(19) United States
(12) Patent Application Publication
(10) Pub. No.: US 2002/0090847 A1
(43) Pub. Date: Jul. 11, 2002

(54) Ground connector

(76) Inventor: Robert De France, Poughkeepsie, NY (US)

Correspondence Address: ALIX YALE & RISTAS LLP, 750 MAIN STREET, SUITE 1400, HARTFORD, CT, 06103, US

(21) Appl. No.: 10/091,730

(22) Filed: Mar. 6, 2002

Related U.S. Application Data
(63) Continuation of application No. 09/726,829, filed on Nov. 30, 2000.

(51) Int. Cl. H01R 4/66

(52) U.S. Cl. 439/100

(57) ABSTRACT

A ground connector for use with an associated distribution transformer which includes a base. The base includes a fixed jaw and a spade connector for attaching the base to the associated distribution transformer. The ground connector also includes a movable member with a movable jaw which includes guide surfaces dimensioned and configured for sliding engagement with guide surfaces of the base to guide movement of the movable jaw with respect to the base. The fixed jaw and the movable jaw form a vise-type clamp which may hold the associated cable generally tangentially to the associated distribution transformer when the ground connector is installed on an associated distribution transformer.

### CROSS-REFERENCE TO RELATED APPLICATION

This application is a continuation of U.S. application Ser. No. 09/726,829, filed on Nov. 30, 2000.

### BACKGROUND OF THE INVENTION

This invention relates to electrical power distribution systems and particularly to attachments for grounding distribution transformers.

Distribution transformers are typically mounted on so-called telephone or utility poles that carry electrical power to local areas. Although such distribution transformers are most visible in residential and commercial locations, it will be understood that the ground connector in accordance with the present invention has application to other electrical connections in other locations as well as to other transformers and other applications that are not related to transformers.

In the case of distribution transformers, it is vital to maintain a positive ground connection. Failure to maintain a positive ground connection will ordinarily result in the destruction of the transformer and in some cases, even fires and other catastrophes. Failure of the transformer will at least cause a local power failure. In the worst case a fire may result which may or may not be localized. When the fire spreads, there is a significant risk of personal injury. Another risk associated with the loss of the ground connection on such transformers is the risk of injury to linemen who may inadvertently touch the transformer and may be severely shocked or electrocuted. Thus, it is of great importance for transformers and other devices to have a very reliable ground connection.

The prior art to which the invention relates includes a wide variety of devices for making electrical connections. Such devices have not, in general, been wholly satisfactory in terms of ease of installation and reliability.

It is of great importance to provide a connector that will maintain a very positive connection of high integrity for long periods of time. It is also a great importance to have a connector that will maintain the connection without maintenance because of the difficulty of accessing the connection that is typically on a utility pole. Because of this location of the ground connector, checking the condition of the connection is problematic. The difficulty is accentuated by the location on a pole, as well as the significant precaution, which must be taken to avoid electrocution. The relative inaccessibility of the connection and the significant safety precautions which must be taken to avoid electrocution make it particularly desirable to provide apparatus which can be installed and maintained with a minimum effort.

An additional design consideration is a very competitive marketplace. It is therefore desirable to provide structure that can be manufactured at a competitive price and installed in an efficient cost-effective manner. The typical ground connector is manufactured from a material that includes at least some copper. Because copper is relatively expensive, it is desirable to provide a structure that utilizes less material than known prior art structures.

A typical distribution transformer has a one-half inch nut welded to the housing thereof for providing the ground connection. Thus, it is desirable that ground-connecting apparatus for such an application readily cooperates with the one-half inch nut that is welded to the transformer housing.

### SUMMARY OF THE INVENTION

An object of the invention is to provide apparatus which will provide a very positive ground connection that can be maintained for long periods of time without the need for maintenance and inspection by linemen.

Another object of the invention is to provide apparatus which can be manufactured in an efficient and cost effective manner and which has an efficient construction.

A further object of the invention is to provide apparatus which can be efficiently installed and connected to an associated ground wire.

It has now been found that these and other objects of the invention may be attained in a ground connector for use with an associated distribution transformer. The connector includes a base which has a fixed jaw and spade-like structure which attaches to the associated distribution transformer. The ground connector also includes a movable member with a jaw. The movable member includes guide surfaces dimensioned and configured for engagement with guide surfaces of the base to guide movement of the movable jaw with respect to the base to form a vise-type clamp. The fixed jaw and the movable jaw cooperate in one installed position to hold the associated cable generally tangentially to the associated distribution transformer when the ground connector is installed on the associated distribution transformer.

In some forms of the invention at least one of the guide surfaces includes a pair of transversely spaced ribs and the other guide surface includes cooperating transversely spaced channels. Some embodiments of the connector in accordance with the invention may include a first bolt extending through the movable member and engaging a threaded bore in the base to permit tightening of the ground connector to clamp a received ground cable.

### BRIEF DESCRIPTION OF THE DRAWING

The invention will better understood by reference to the accompanying drawing in which:

FIG. 1 is a perspective view of a first embodiment of a ground connector in accordance with the present invention.

FIG. 2 is an exploded view of the ground connector illustrated in FIG. 1, and which illustrates a cooperating rib and channel guide feature.

FIG. 3 is a perspective view of the ground connector illustrated in FIGS. 1 and 2 and further illustrating a preferred application with an associated ground cable and with an associated distribution transformer.

FIG. 4 is a perspective view of a second embodiment of the ground connector in accordance with the present invention.

FIG. 5 is an exploded view of the ground connector shown in FIG. 4.

FIG. 6 is an elevational representational view of a typical installation of a distribution transformer and power line and which illustrates a preferred environment for the ground connector in accordance with the present invention.

### DESCRIPTION OF THE PREFERRED EMBODIMENTS

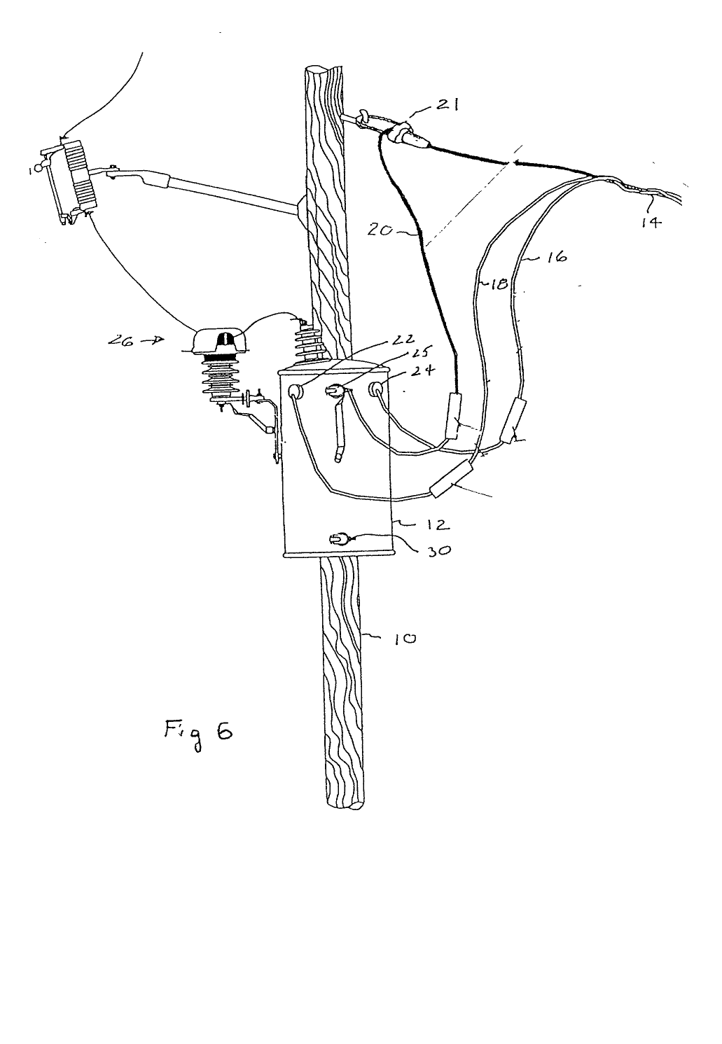

Referring now to FIG. 6, there is shown a typical utility pole 10 on which is mounted a generally cylindrical distribution transformer 12. A power line 14 includes phase conductors 16, 18 as well as a neutral conductor 20. The phase conductors 16, 18 and neutral conductor 20 are fixed to the distribution transformer 12 at connections 22, 24, and 25. A dead end 21 secures the cable 14 to the utility pole 10. The typical installation illustrated in FIG. 6 includes a lightning arrestor system 26. In the typical manner a nut 30 is welded to the housing of the distribution transformer 12 near the lower axial extremity thereof.

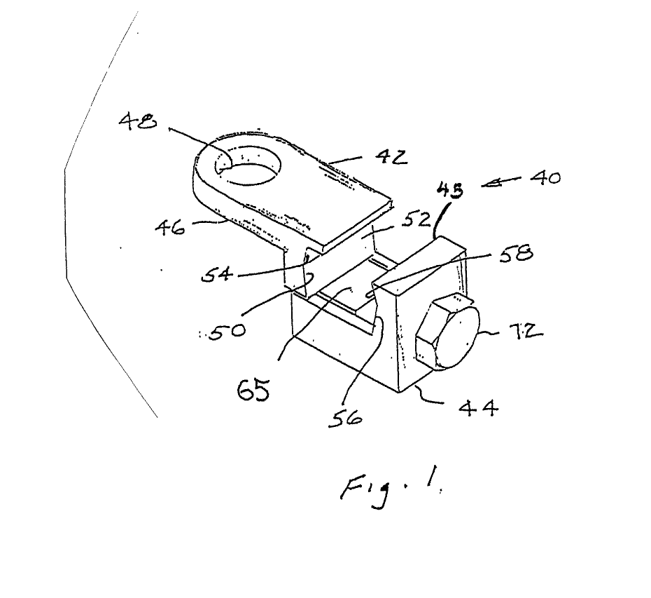

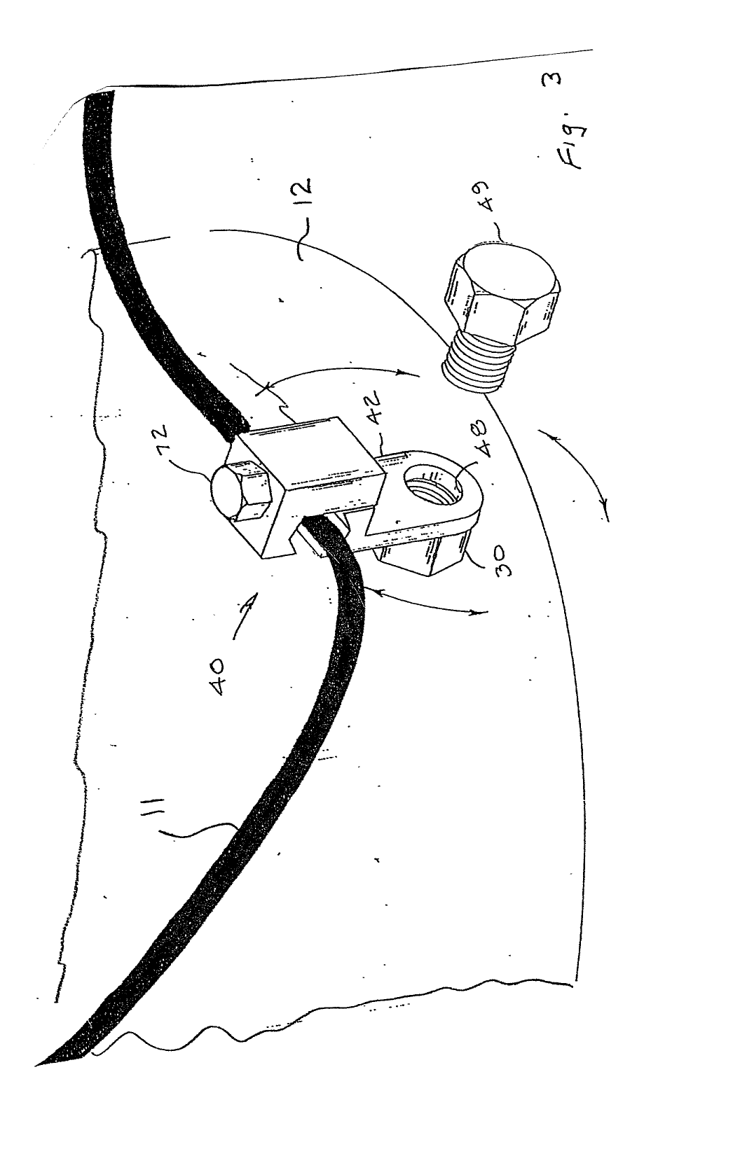

The connector 40 illustrated in FIGS. 1, 2, and 3 includes a base 42 and a movable member 44 which are preferably formed from copper, brass or other conductive metallic compositions. The base 42 includes a spade shaped extension 46 having an aperture 48 disposed therein. The aperture 48 is dimensioned and configured for receiving a bolt 49 (FIG. 3) that threadably engages the nut 30 that is welded to the housing of the distribution transformer 12. The base 42 also includes a fixed jaw 50 that is essentially fixed relative to the aperture 48. Accordingly, when the ground connector 40 is secured to the nut 30 by torquing the bolt 49, the fixed jaw 50 is fixed with respect to the nut 30. The fixed jaw 50 includes intersecting planar faces 52 and 54 having included angle therebetween of approximately 140 degrees.

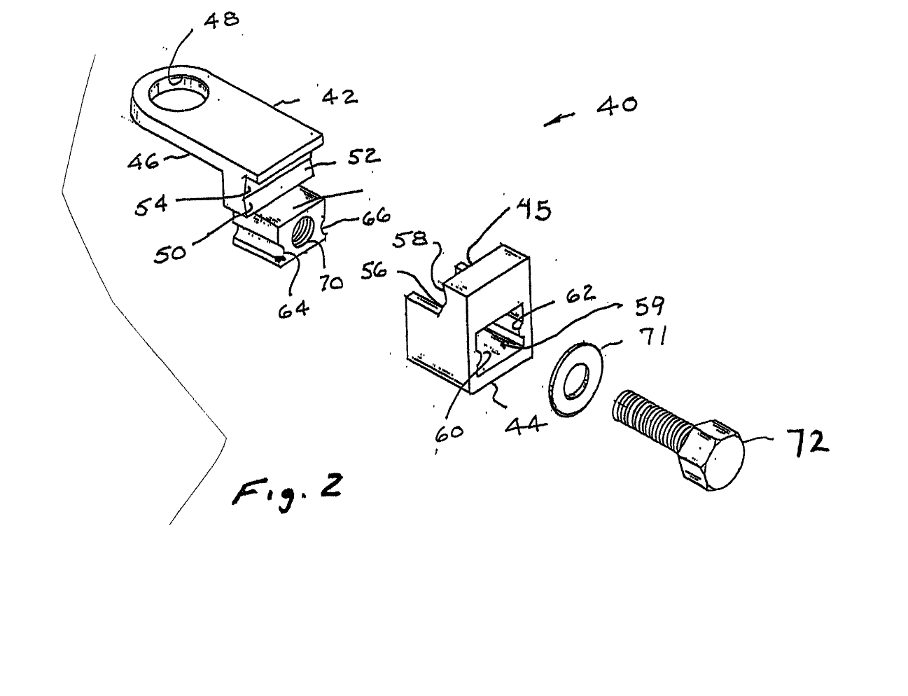

The movable member 44 includes a movable jaw 45 defined by planar faces 56, 58 having an included angle therebetween of approximately 140 degrees. As best seen in FIG. 2, the movable member 44 has a receiving cavity 59 with transversely spaced interior sides which are provided with inwardly protruding, elongated ribs 60, 62. The opposed ribs 60, 62 slidably engage and cooperate with channels 64, 66 formed in a guide part 64 of the base 42. The guide part 64 also includes a threaded bore 70 that receives the bolt 72 (on which a washer 71 is preferably disposed). The head of the bolt or washer engages the end of the moveable member and extends through the cavity 59. Accordingly, the user can tighten the movable jaw 44 with respect to the fixed jaw 52 by torquing the bolt 72.

Referring now to FIG. 3, the ground connector 40 may be efficiently installed to the nut 30 welded to the transformer housing by threading the bolt into the nut through the opening 48 of the spade connector. The ground cable 11 is positioned between the fixed and moveable jaw. The bolt is then torqued to clamp the jaws together and implement a reliable secure clamp into the ground cable. It should be appreciated that in one preferred orientation, the clamp portion of the cable is essentially tangential to the cylindrical housing of the transformer. It will also be appreciated that the ground connector may be installed by first securing the ground cable to the clamp and then securing the connector to the transformer. The ground connector is configured so that the clamp receiving cradle formed by the jaws, as well as the bolts 72 and 49 are very accessible to the installer.

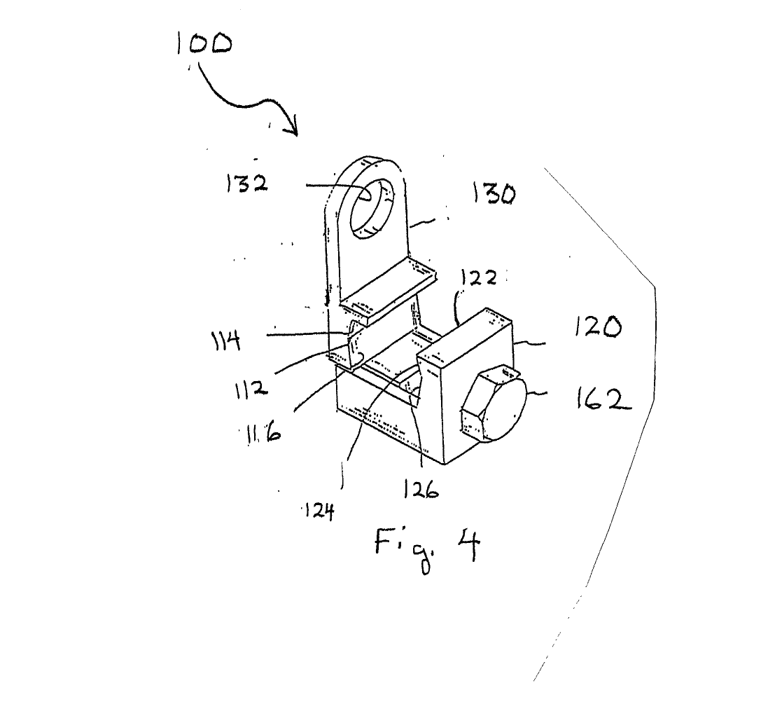

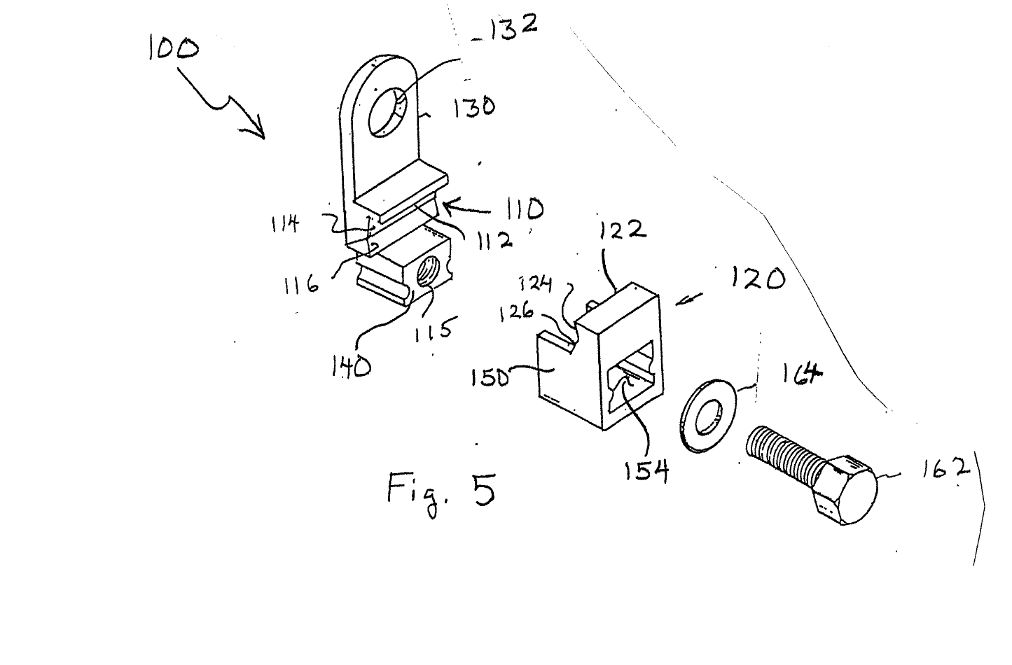

Referring now to FIGS. 4 and 5, there is shown a second embodiment of the ground connector in accordance with the present invention. The connector is generally designated by the numeral 100. This connector 100 includes a base 110 and a movable member 120. As in the other embodiment, the base 110 includes a fixed jaw 112. The fixed jaw 112 has generally planar faces 114 and 116 which intersect with an included angle of approximately 140 degrees. Upon installation, the intersection of the generally planar faces 104 and 106 defines a line that is parallel to a plane (not shown) that is tangent to the face of the distribution transformer at the nut 30.

The movable member 120 has a jaw 122 defined by generally planar intersecting faces 124 and 126 having an included angle therebetween of approximately 140 degrees. Upon installation, the intersection of the generally planar intersecting faces 124 and 126 defines a line that is also parallel to a plane (not shown) that is tangent to the distribution transformer at the nut 30 on the side of the distribution transformer.

The jaws 112, 122 have generally congruent opposed clamp surfaces which are longitudinally spaced and form a cradle for receiving a ground cable and clamping the cable in a vise-type fashion. The base 110 includes a spade shaped extension 130. An aperture 132 therein is dimensioned and configured for receiving a bolt (not illustrated) that will threadably engage the nut 30 on the distribution transformer 12.

With reference to FIG. 5, ground connector 100 also has cooperative guide structures 140, 150 which employ cooperating ribs 152 and channels 142 to guide the relative movement of the movable jaw 120 with respect to the base 110. The movable member forms a cavity 154 which receives the cooperative guide structure 140 of the base 110. A bolt 160 having a head 162 which optionally captures a washer 164 extends through the movable member into a threaded bore 144 in the base 110. It will be seen that this embodiment is also particularly convenient for a lineman to use because of the orientation of the jaws.

It will be seen that all embodiments of the present invention have jaws mounted to hold the ground cable in substantially tangential relationship to a side of the distribution transformer. The ground cable typically extends around the distribution transformer to the ground connector on the base of the transformer and then to actual ground in the manner generally shown in FIG. 3. The positioning of the jaws to hold the cable in tangential relationship to the transformer is a desirable benefit of the apparatus in accordance with present invention. Such an arrangement is convenient for the linemen and in addition reliably and securably holds the ground cable.

While the present invention has been described with reference to the preferred embodiments illustrated in the drawing, the detailed description thereof is not intended to limit the scope of the invention as claimed in the appended claims.

What is claimed:

1. A ground connector for use with an associated distribution transformer which comprises:
a base, said base having a spade connector defining an opening and comprising a fixed jaw and a first guide portion; and
a movable member, said movable member defining a receiving cavity and comprising a movable jaw and a second guide portion, said cavity receiving said first guide portion wherein said first guide portion and said second guide portion are configured for sliding engagement to guide longitudinal movement of said movable member with respect to said base to form a vise-type clamp; and
securement means for securing said base and movable member so that when a cable is received between said fixed jaw and said movable jaw, said jaws are securably clampable against said cable.

2. The ground connector of claim 1, wherein one of said first and second guide portions includes a pair of transversely spaced longitudinally extending ribs.

3. The ground connector of claim 2, wherein the other of said first and second guide portions has a pair of transversely spaced channels dimensioned and configured for sliding engagement with said ribs.

4. The ground connector of claim 3, wherein said first guide portion has ribs and said second guide portion has channels.

5. The ground connector of claim 1, wherein said securement means comprises a first bolt engagable with said movable member and threadably engaged to said base.

6. The ground connector of claim 1, wherein said fixed jaw and said movable jaw are each defined by a pair of intersecting surfaces which extend transversely to the longitudinal movement of said movable member.

7. The ground connector of claim 1, wherein said movable member defines a longitudinal axis, said spade connector defining a plane parallel to said axis.

8. The ground connector of claim 1, wherein said movable member defines a longitudinal axis, said spade connector defining a plane orthogonal to said axis.

9. A ground connector installation comprising:
a distribution transformer having a generally cylindrical shaped housing and having a ground connecting means;
a base, said base having a spade connector defining an opening and comprising a fixed jaw and a first guide portion;
a movable member, said movable member defining a receiving cavity and comprising a movable jaw and a second guide portion, said cavity receiving said first guide portion wherein said first guide portion and said second guide portion are configured for sliding engagement to guide longitudinal movement of said movable member with respect to said base to form a vise-type clamp;
securement means for securing said base and movable member so that when a cable is received between said fixed jaw and said movable jaw, said jaws are securably clampable against said cable; and
a bolt extending through said opening into said ground connecting means for mounting said base to said transformer.

10. The installation of claim 9, further comprising a cable secured in said clamp.

11. The installation of claim 10, wherein said cable includes a portion secured in said clamp which portion is tangential to said transformer housing.

12. The ground connector of claim 3, wherein said first guide portion has ribs and said second guide portion has cooperating channels.

13. The installation of claim 9, wherein said ground connecting means is a nut welded to said housing.
